(19) United States
(12) Patent Application Publication
(10) Pub. No.: US 2017/0123626 A1
(43) Pub. Date: May 4, 2017

(54) VEHICLE OPERATION SYSTEM

(71) Applicant: Yazaki Corporation, Tokyo (JP)

(72) Inventors: Takafumi SAITO, Shizuoka (JP); Yoshiyuki MIZUNO, Shizuoka (JP)

(21) Appl. No.: 15/340,617

(22) Filed: Nov. 1, 2016

(30) Foreign Application Priority Data
Nov. 4, 2015 (JP) 2015-216512

(51) Int. Cl. G06F 3/0481; B62D 1/04; B60K 35/00; G06F 3/0488; G06F 3/0484

(52) U.S. Cl. CPC G06F 3/04815; G06F 3/04817; G06F 3/04883; G06F 3/04845; B60K 35/00; B62D 1/046; G06F 3/0482

(57) ABSTRACT

A contact operating region in an input device disposed on a vehicle front side than a steering wheel and at a position which is operable by an operator without releasing his hand from the steering wheel has at least one reference operation surface, and a three-dimensional operation surface. A virtual input section graphic and a plurality of selection icons are displayed on a display region of a display device, the virtual input section graphic having a virtual reference operation surface and a virtual three-dimensional operation surface, the plurality of selection icons being related to the operation of a vehicle onboard device disposed to be spaced apart from each other. A controller moves the virtual input section graphic and the selection icons in the direction in which the virtual reference operation surface and the virtual three-dimensional operation surface are alternately connected.

### CROSS-REFERENCE TO RELATED APPLICATION(S)

The present application claims priority to and incorporates by reference the entire contents of Japanese Patent Application No. 2015-216512 filed in Japan on Nov. 4, 2015.

### BACKGROUND OF THE INVENTION

1. Field of the Invention

The present invention relates to a vehicle operation system.

2. Description of the Related Art

As vehicle operation systems, a vehicle operation system configured so that an operator can operate a vehicle onboard device mounted on a vehicle without releasing his hand from a steering wheel is known. For example, the following Japanese Patent Application Laid-open No. 2014-144693 discloses a vehicle operation system which includes a lever operation unit provided on a steering column, and a detecting unit of a motion of hand or finger provided at the tip of the lever operation unit. Further, Japanese Patent Application Laid-open No. 2014-43232 discloses a vehicle operation system including a touch-pad type input device (a so-called steering pad switch) which is provided on the steering pad or its periphery. In the vehicle operation system, in order to allow an intuitive operation, the input device includes a three-dimensional contact operating region, and a display device includes a three-dimensional display region that is substantially similar to the shape of the contact operating region. For example, in such a vehicle operation system, a plurality of selection icons is displayed along a peripheral edge portion (a step) having a V shape of the contact operating region to trace the selection icons with a finger along the peripheral edge portion (the step) having the V shape of the contact operation range, thereby selecting the icons. Further, Japanese Patent Application Laid-open No. 2013-121805 discloses a vehicle operation system which has improved operability by displaying the same shape as the touch-pad type contact operating region on the display device.

Here, in the techniques of Japanese Patent Application Laid-open Nos. 2014-43232 and 2013-121805, because the contact operating region is disposed in a visible location, an operator easily recognizes a correspondence relation between the contact operating region and the display region, and it is possible to obtain an operational feeling as to which type of operation is performed. However, when the contact operating region is disposed at a position hard to be visible (for example, the tip of the lever operation unit), there is room for improvement in terms of giving a good operational feeling to the operator. Further, Japanese Patent Application Laid-open No. 2007-72660 discloses a visible touch-pad which has an operation surface with irregularities alternately disposed along a sliding operation direction, and in which movement quantity of a cursor of a display device is made to correspond to predetermined intervals of the irregularities. Further, Japanese Patent No. 3792920 discloses a vehicle operation system which includes a visible touch-pad having a planar contact operating region divided into a plurality of sections, and a groove-like contact operating region interposed between the adjacent planar contact operating regions, and in which each of the contact operating regions and a selection icon superimposed for each of the contact operations regions are displayed on the display device.

### SUMMARY OF THE INVENTION

An object of the present invention is to provide a vehicle operation system that is capable of improving the operational feeling of the contact operating region disposed at a position hard to be visible.

In order to achieve the above mentioned object, a vehicle operation system according to one aspect of the present invention includes an input device including at least one contact operating region and a motion detecting unit, the one contact operating region being disposed on a vehicle front side than a steering wheel and at a position which is operable by an operator without releasing his hand from the steering wheel, and being performed a contact operation with fingers thereto when the operator operates a vehicle onboard device, the motion detecting unit being capable of detecting a contact operation pattern of the operator to the contact operating region; a display device that displays information on an operation of the vehicle onboard device; and a controller configured to send a command to the vehicle onboard device and the display device, based on an output signal of the motion detecting unit according to the contact operation pattern, wherein the contact operating region has at least one reference operation surface, has at least one of a protruding operation surface protruding to the reference operation surface and a recessed operation surface recessed to the reference operation surface, as a three-dimensional operation surface, and sets a direction in which the reference operation surface and the three-dimensional operation surface are alternately connected, as an operating direction of a sliding operation of an operator's finger, a virtual input section graphic and a plurality of selection icons are displayed on a display region of the display device, the virtual input section graphic having a virtual reference operation surface which simulates the reference operation surface, and a virtual three-dimensional operation surface which simulates the three-dimensional operation surface, the plurality of selection icons being related to the operation of the vehicle onboard devices disposed to be spaced apart from each other in a direction in which the virtual reference operation surface and the virtual three-dimensional operation surface are alternately connected, and the controller moves the virtual input section graphic and the selection icon in a direction in which the virtual reference operation surface and the virtual three-dimensional operation surface are alternately connected, in accordance with the operating direction of the sliding operation detected on the basis of the output signal of the motion detecting unit.

According to another aspect of the present invention, in the vehicle operation system, it is desirable that a central portion of the steering wheel and a central portion of the display region are made to correspond to each other, and the virtual input section graphic is displayed on the display region in such a manner that an arrangement of the virtual reference operation surface and the virtual three-dimensional operation surface to the central portion of the display region is made to correspond to an arrangement of the contact operating region to the central portion of the steering wheel, and the direction in which the virtual reference operation surface and the virtual three-dimensional operation surface are alternately connected is made to correspond to the operating direction of the sliding operation.

According to still another aspect of the present invention, in the vehicle operation system, it is desirable that the virtual three-dimensional operation surface is emphatically displayed.

According to still another aspect of the present invention, in the vehicle operation system, it is desirable that when the sliding operation to the contact operating region is assumed as an operation along an arc-shaped circumferential direction, the virtual input section graphic having the arc-shaped virtual reference operation surface and the virtual three-dimensional operation surface made to correspond to the circumferential direction, and a plurality of selection icons disposed to be apart from one another along the circumferential direction of the virtual reference operation surface are displayed on the display region, and the controller rotates the virtual input section graphic and the selection icons in the circumferential direction of the virtual reference operation surface, in accordance with the operating direction of the sliding operation which is detected on the basis of the output signal of the motion detecting unit.

According to still another aspect of the present invention, in the vehicle operation system, it is desirable that the reference operation surface is formed in an arc shape in accordance with the virtual reference operation surface.

According to still another aspect of the present invention, in the vehicle operation system, it is desirable that the virtual input section graphic is a three-dimensional figure which represents a disc, a fan body, an annular body or a part of the annular body, and the virtual input section graphic has the virtual reference operation surface and the virtual three-dimensional operation surface on an outer circumferential surface thereof.

According to still another aspect of the present invention, in the vehicle operation system, it is desirable that the virtual input section graphic has at least one set of a combination of a simulated reference operation surface that simulates the virtual reference operation surface and a simulated three-dimensional operation surface that simulates the virtual three-dimensional operation surface on the outer circumferential surface, and the combination of the simulated reference operation surface and the simulated three-dimensional operation surface is disposed to be connected to the combination of the virtual reference operation surface and the virtual three-dimensional operation surface, in the direction in which the virtual reference operation surface and the virtual three-dimensional operation surface are alternately disposed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view illustrating a configuration of a vehicle operation system of an embodiment and first and second modified examples;

FIG. 2 is a top view illustrating the configuration of the vehicle operation system of the embodiment and the first and second modified examples;

FIG. 3 is a perspective view explaining an input member of the embodiment;

FIG. 4 is a diagram explaining an example of a sliding operation;

FIG. 5 is a diagram explaining an example of a touch operation;

FIG. 6 is a perspective view explaining a conductor of the embodiment;

FIG. 7 is a cross-sectional view of the input member and the conductor taken along the line X-X of FIG. 3;

FIG. 8 is a diagram illustrating a flat plate-like virtual input section graphic and selection icons;

FIG. 9 is a diagram illustrating an example of an annular virtual input section graphic and the selection icons;

FIG. 10 is a diagram explaining the operation of the virtual input section graphic and the selection icons from an upper diagram of FIG. 9;

FIG. 11 is a diagram explaining an example of the operation of the virtual input section graphic and the selection icons from a lower diagram of FIG. 10;

FIG. 12 is a diagram explaining another example of the operation of the virtual input section graphic and the selection icons from a lower diagram of FIG. 10;

FIG. 13 is a perspective view explaining an input member of a first modified example;

FIG. 14 is a perspective view explaining an input member of a second modified example; and

FIG. 15 is a front view illustrating a configuration of a vehicle operation system of a third modified example.

### DETAILED DESCRIPTION OF THE PREFERRED EMBODIMENTS

Embodiments of a vehicle operation system according to the present invention will be described below in detail with reference to the drawings. Further, it should be understood that the present invention is not limited by the embodiments.

### Embodiment

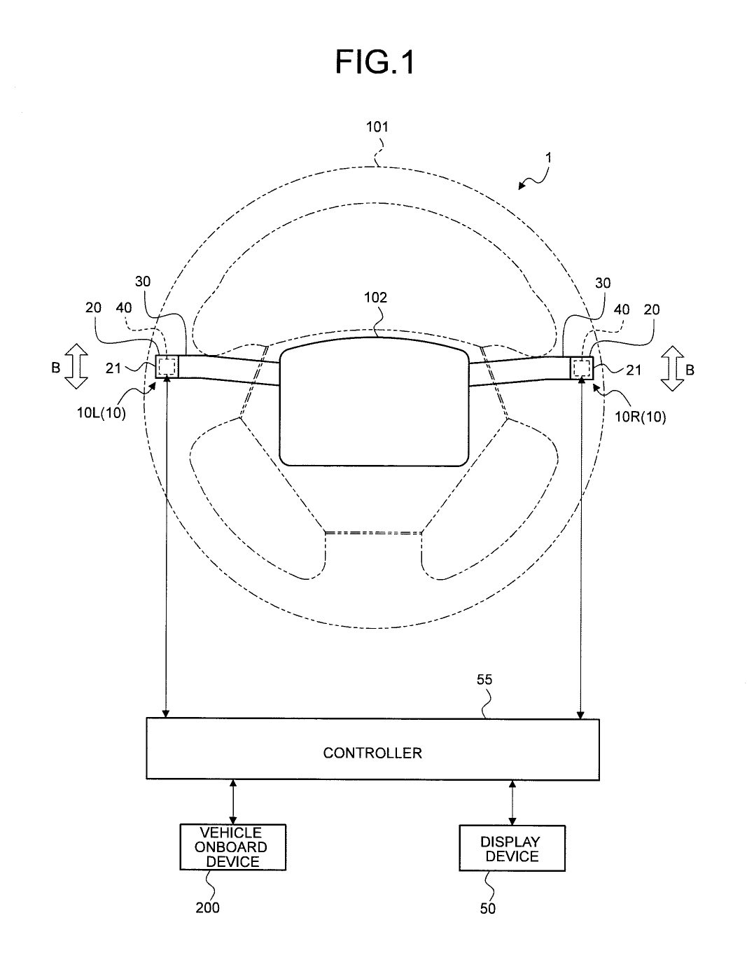

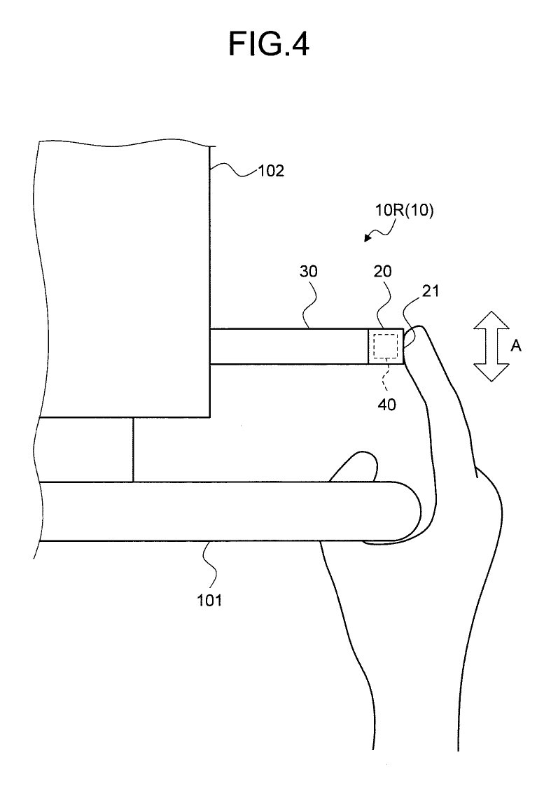

An embodiment of a vehicle operation system according to the present invention will be described with reference to FIGS. 1 to 12.

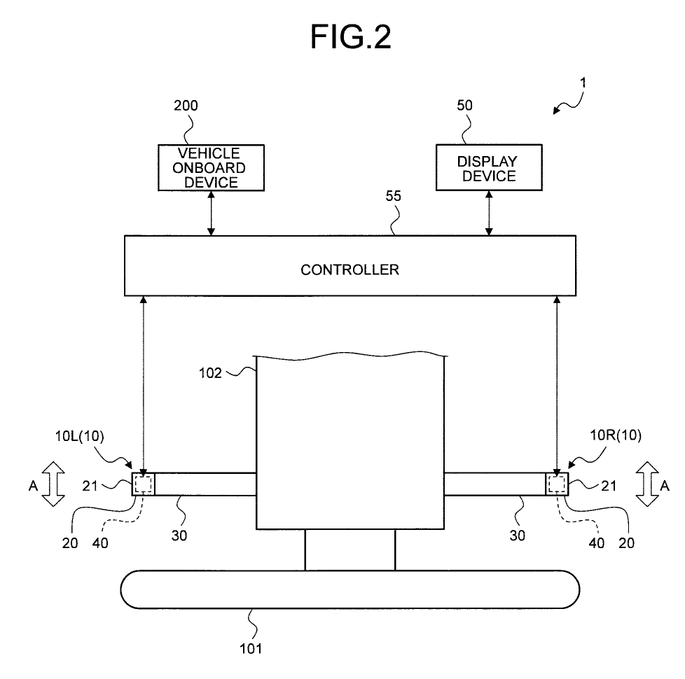

Reference number 1 of FIGS. 1 and 2 illustrates a vehicle operation system of the present embodiment. The vehicle operation system 1 is configured so that an operation of a vehicle onboard device 200 mounted on a vehicle can be performed, without releasing an operator (driver)'s hand from a steering wheel 101.

Here, the vehicle onboard device 200 has at least one function (an operating pattern) operated with the operation of the vehicle operation system 1 performed by an operator. For example, as the vehicle onboard device 200, there are devices mounted on the vehicle interior, for example, an audio device such as audio equipment and a radio set, and an air conditioning device (a so-called air conditioner). Further, as the vehicle onboard device 200, there is also a device (for example, a mobile phone and a portable music player) that is not mounted on a vehicle itself but is mounted on the vehicle by carrying into a vehicle interior. Further, the vehicle onboard device 200 may be a lamp device of the vehicle (headlights and tail lights), direction indicators, windshield wipers and the like.

The vehicle operation system 1 of the present embodiment includes an input device 10 which is used for an operator to operate the vehicle onboard device 200. The input device 10 is disposed on a vehicle front side than the steering wheel 101 (that is, a rear side of the steering wheel 101), and in at least one of a left side (a vehicle left side) and a right side (a vehicle right side) in a vehicle width direction as viewed from a central portion of the steering wheel 101. In the example of FIGS. 1 and 2, the equivalent input device 10 is provided on each of the vehicle left side and the vehicle right side (input devices 10L and 10R). Each of the input devices 10L and 10R is configured to be laterally symmetrical as viewed from the central portion of the steering wheel 101. Therefore, as needed, the input device 10 will be described below as an example on behalf of the input device 10R of the vehicle right side.

The input device 10 includes an input member 20 for the operator to perform a contact operation with a finger. The input member 20 is disposed on the vehicle front side than the steering wheel 101, and at a position which is operable by an operator, without releasing his hand from the steering wheel 101. The position is a place that the fingertips of the fingers (for example, the middle finger or index finger) can reach, while the operator grasps the steering wheel 101. This position may be any location as long as the position is in the vicinity of the rim of the steering wheel 101, but it is desirable to provide the position in the vicinity of the holding and steering position of the steering wheel 101 by a common operator. Therefore, in this example, in the case of the input device 10L on the vehicle left side, the input member 20 is disposed in a left end portion or in the vicinity of the left end portion in the vehicle width direction of the steering wheel 101, and in the case of the input device 10R on the vehicle right side, the input member 20 is disposed in a right end portion or in the vicinity of the right end portion in the vehicle width direction of the steering wheel 101.

The input member 20 is held in any part of the vehicle interior to achieve the arrangement. The input member 20 of this embodiment is held by a steering column 102 via a connecting member 30. The connecting member 30 is formed as a cylindrical longitudinal member, for example, by a synthetic resin material, and is disposed in a state of protruding from the steering column 102 in a predetermined direction, by attaching the longitudinal one end to the steering column 102. As long as the connecting member 30 extends between the steering column 102 and the input member 20, the connecting member 30 may be formed into a straight shape, and a bend portion may be provided in the middle of the path. The predetermined direction is a direction that is directed toward the input member 20 from the steering column 102. For example, the predetermined direction includes a radial direction, a right oblique upward direction directed toward the vehicle right and the vehicle top, a right oblique downward direction directed toward the vehicle right and the vehicle bottom, a left oblique upward direction directed toward the vehicle left and vehicle top, a left oblique downward direction directed toward the vehicle left and the vehicle bottom, and a direction further inclined to the vehicle rear side based on the end portion of the steering column 102 side as a fulcrum in each direction. The connecting member 30 of the input device 10L extends the other end (the end portion in the protruding direction) to a position that the operator who grasps the left end portion or the vicinity of the left end portion in the vehicle width direction of the steering wheel 101 touches with his fingers. Further, the connecting member 30 of the input device 10R extends the other end (the end portion in the protruding direction) to a position that the operator who grasps the right end portion or the vicinity of the right end portion in the vehicle width direction of the steering wheel 101 can touch with his fingers. The input member 20 is disposed on the other end side of the connecting member 30 and is attached to the other end. As a result, the operator can touch the input member 20 with his fingers, while grasping the steering wheel 101.

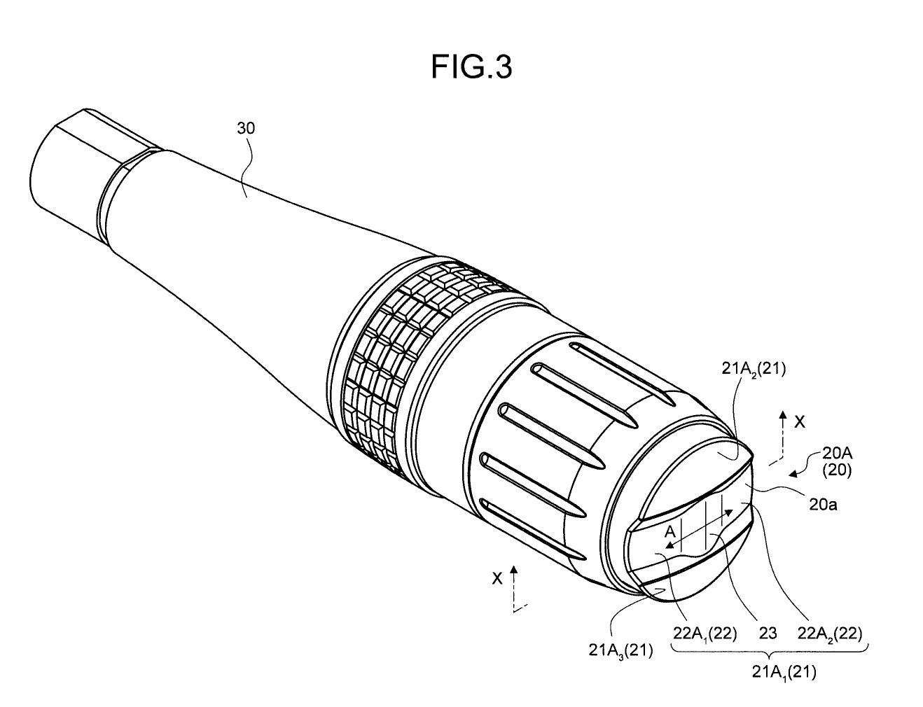

FIG. 3 illustrates a specific example (the input member 20A) of the input member 20. The input member 20A is formed into a cylindrical shape with blocked one end, using a synthetic resin material or the like (FIG. 3). The input member 20A is fitted and attached to the opening of the tip of the connecting member 30 so that the axial direction thereof is made to match the axial direction of the other end (hereinafter, referred to as “tip”) side of the connecting member 30, and a disc-shaped blocking portion 20a is located at the most tip side. On an outer wall side of the blocking portion 20a, at least one contact operating region 21 is provided to perform a contact operation with a finger when the operator operates the vehicle onboard device 200. The contact operating region 21 is disposed on the vehicle front side than the steering wheel 101, and at a position which is operable by the operator, without releasing his hand from the steering wheel 101.

The contact operating region 21 (when there is a plurality of contact operating regions 21, at least one of them) is set so that the operator can perform the sliding operation along the natural movement of his finger, while grasping the steering wheel 101. The natural movement of the finger of the operator is an operation of the finger which can be performed by the operator without difficulty, that is, an operation of the finger that does not give uncomfortable feeling to the operator. The sliding operation is an operation that makes the fingers slide, while touching the contact operating region 21. For example, the operating direction of the sliding operation is set to a direction along a bending and stretching direction (a direction of arrows A in FIGS. 2 to 4) of the fingers of the operator (for example, the middle finger and the index finger) that grasp the steering wheel 101. In this case, in the contact operating region 21, a contact operation pattern is at least set in which the bending and stretching direction of the fingers of the operator grasping the steering wheel 101 is the operating direction of the sliding operation. Accordingly, the input member 20A of this case is disposed to allow the operator to perform the sliding operation of the contact operating region 21 when the operator bends and stretches the fingers. Further, the operating direction of the sliding operation may be set in a direction (a direction of arrow B in FIG. 1) perpendicular to the bending and stretching direction of the fingers of the operator who grasps the steering wheel 101. The reason is that such an operating direction also extends along the natural movement of the fingers of the operator, while grasping the steering wheel 101.

In the input member 20A of the example, the outer wall side of the blocking portion 20a is divided into three regions along the radial direction, and each of the three regions is used as the contact operating region 21 (first to third operation regions 21A₁, 21A₂ and 21A₃). In the input member 20A disposed as illustrated above, the dividing direction of the blocking portion 20a is a direction perpendicular to the natural movement of the fingers of the operator, while grasping the steering wheel 101. Thus, in the contact operating region 21 in which the sliding operation is set as the contact operation pattern, the operator can perform the sliding operation along the natural movement of his fingers, while grasping the steering wheel 101.

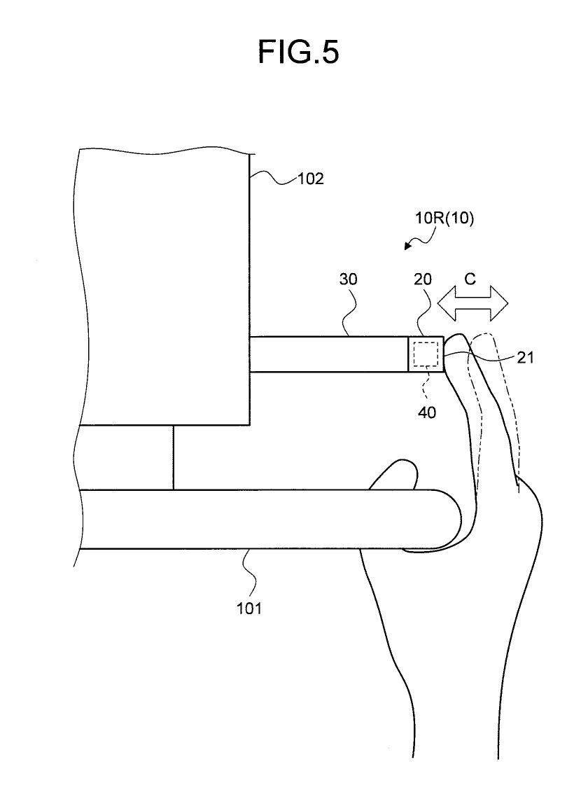

In this example, as the contact operation pattern, at least the sliding operation is allocated to the first contact operating region 21A₁, and the touch operation is allocated to the second and third contact operating regions 21A₂ and 21A₃. Selecting operation functions (that is, information about the operation of the vehicle onboard device 200) can be allocated to the sliding operation. The selecting operation functions, for example, include a device selecting operation for selecting a desired device from a plurality of vehicle onboard devices 200, a function selecting operation for selecting a desired function from a plurality of functions of the vehicle onboard device 200, or a condition selecting operation for selecting a desired selection condition from a plurality of selection conditions included in the function. The function selecting operation, for example, is an operation of selecting a desired function from a media selecting function, a sound volume selecting function, a track selecting function and the like, when the vehicle onboard device 200 is a sound device. The condition selecting operation, for example, is an operation of selecting a desired sound volume, when the sound volume selecting function is selected. The touch operation is an operation of touching the contact operating region 21 with the fingers, by moving the fingers in the direction of arrow C in FIG. 5. For example, a determination operation function performed when determining the function and the selection condition selected by the sliding operation, and a return operation function for immediately returning to the selecting operation of one previous class and the selecting operation of the first layer can be allocated to the touch operation. As the touch operation, it is possible to set one touch operation or a plurality of consecutive hit operations.

The first contact operating region 21A₁ is interposed between the second contact operating region 21A₂ and the third contact operating region 21A₃. The first contact operating region 21A₁ is a substantially rectangular region that is surrounded by two linear parallel sides extending along the natural movement of the fingers of the operator (here, the movement in the bending and stretching direction), and two arc-shaped sides connecting the two sides on both end sides of the movement of the fingers (an extension side and a contraction side). The sliding operation along the two linear sides is set in the first contact operating region 21A₁.

The first contact operating region 21A₁ is recessed deeper than the second contact operating region 21A₂ and the third contact operating region 21A₃, and provides a step between the second and third contact operating regions 21A₂ and 21A₃. Thus, because the operator can grasp a boundary portion between the first contact operating region 21A₁ and the second contact operating region 21A₂, and a boundary portion between the first contact operating region 21A₁ and the third contact operating region 21A₃ with fingers, although the first contact operating region 21A₁ is disposed at a position hard to be visible, it is possible to recognize the operating direction of the sliding operation of the first contact operating region 21A₁ along the boundary portion by the tactile sense.

The contact operating region 21, in which the sliding operation is set, has at least one reference operation surface 22, and has at least one of a protruding operation surface protruding to the reference operation surface 22 and a recessed operation surface recessed to the reference operation surface 22, as a three-dimensional operation surface 23. The protruding operation surface protrudes to the finger side of the operator from the reference operation surface 22. The recessed operation surface is recessed deeper than the reference operation surface 22 on the opposite side to the protruding direction of the protruding operation surface. In the contact operating region 21, the reference operation surface 22 and the three-dimensional operation surface 23 are alternately disposed. Further, in the contact operating region 21, a direction, in which the reference operation surface 22 and the three-dimensional operation surface 23 are alternately connected, is set as the operating direction of the sliding operation of the fingers of the operator.

The first contact operating region 21A₁ of this example has two reference operation surfaces 22 (first and second reference operation surfaces 22A₁ and 22A₂), and a single three-dimensional operation surface 23 which is interposed between the reference operation surfaces 22. The first and second reference operation surfaces 22A₁ and 22A₂ may be a plane perpendicular to the axis direction of the input member 20A, and may be an arc-shaped curved surface in which the operating direction of the sliding operation is set as the circumferential direction. Here, the latter arc-shaped first and second reference operation surfaces 22A₁ and 22A₂ are illustrated as an example. The first and second reference operation surfaces 22A₁ and 22A₂ are formed in an arc shape to match a virtual reference operation surface 61 (a first virtual reference operation surface 61A₁ and a second virtual reference operation surface 61A₂) which will be described later. The three-dimensional operation surface 23 of this example is a protruding operation surface which is disposed between the first and second reference operation surfaces 22A₁ and 22A₂, and substantially at the center of the first contact operating region 21A₁. The three-dimensional operation surface 23 is formed to have a size and a shape (a height, a depth, an area, and the like) that allows the operator to recognize its presence by the tactile sense, regardless of the protruding operation surface and the recessed operation surface. Thus, the operator can recognize the presence of the first contact operating region 21A₁ disposed at a position hard to be visible from a difference in shape between the first and second reference operation surfaces 22A₁ and 22A₂ and the three-dimensional operation surface 23 grasped by the tactile sense. Further, the difference in the shape capable of being grasped by the tactile sense can enhance an actual feeling of performing the sliding operation on the first contact operating region 21A₁ to the operator.

The second contact operating region 21A₂ is disposed on the vehicle upper side with respect to the first contact operating region 21A₁. The second contact operating region 21A₂ is a region which is surrounded by a one side on a straight line of the vehicle upper side in the first contact operating region 21A₁, and an arc-shaped one side connecting both ends of the one side and bulging to the vehicle upper side. Meanwhile, the third contact operating region 21A₃ is disposed on the vehicle lower side with respect to the first contact operating region 21A₁. The third contact operating region 21A₃ is a region which is surrounded by a one side on a straight line of the vehicle lower side in the first contact operating region 21A₁, and an arc-shaped one side connecting both ends of the one side and bulging to the vehicle lower side. The second and third contact operating regions 21A₂ and 21A₃ may be a planar or may be a curved surface. Here, the latter will be illustrated as an example.

The vehicle operation system 1 includes a motion detecting unit 40 that is able to detect an operation pattern of the operator to the contact operating region 21 (the first to third contact operating regions 21A₁, 21A₂ and 21A₃) (FIGS. 1 and 2). The motion detecting unit 40 is a contact-type sensor configured to detect a contact operation for each contact operating region 21, and is disposed inside the input member 20A. A capacitive sensor is used as the motion detecting unit 40 of this example.

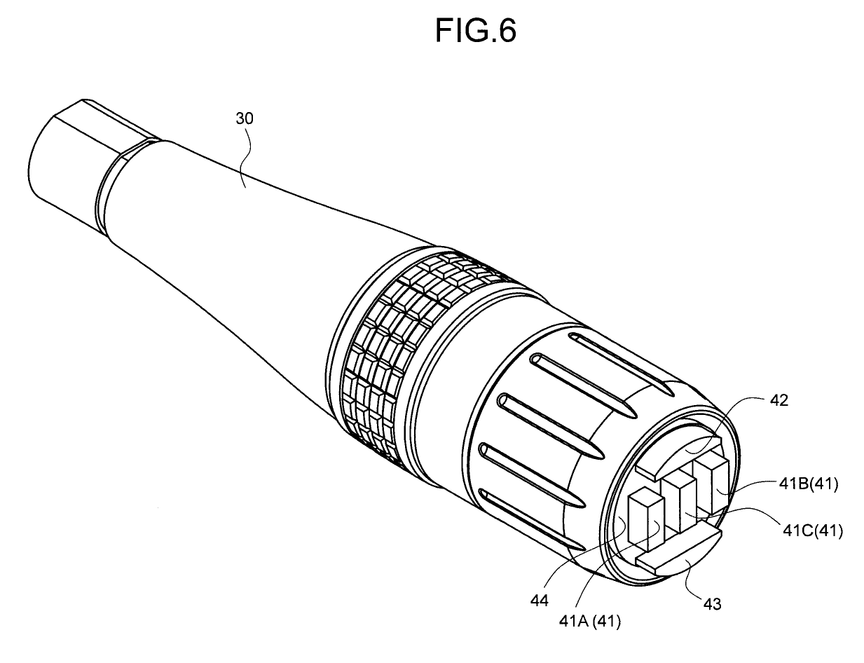

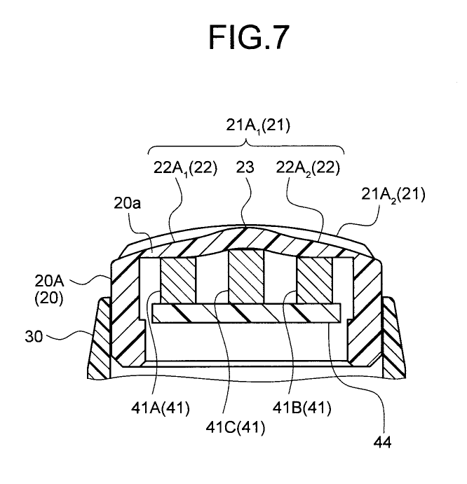

The motion detecting unit 40 includes a conductor 41 for the first contact operating region 21A₁, a conductor 42 for the second contact operating region 21A₂, and a conductor 43 for the third contact operating region 21A₃ to be spaced apart from each other (FIGS. 6 and 7). For the first contact operating region 21A₁, three conductors 41 (first to third conductors 41A, 41B and 41C) are disposed to be spaced apart from each other to detect the operating direction of the sliding operation, and to discriminate which one of the first and second reference operation surfaces 22A₁ and 22A₂ and the three-dimensional operation surface 23 is operated. The first conductor 41A is disposed to correspond to the first reference operation surface 22A₁. The second conductor 41B is disposed to correspond to the second reference operation surface 22A₂. The third conductor 41C is disposed to correspond to the three-dimensional operation surface 23. The conductor 42 is disposed to correspond to the second contact operating region 21A₂. The conductor 43 is disposed to correspond to the third contact operating region 21A₃. The motion detecting unit 40 includes a circuit board 44 provided with a circuit pattern which is electrically connected to each of the conductors 41 to 43 (for each of the first to third conductors 41A, 41B and 41C in the conductor 41). For example, in the input device 10, a capacitive sensor is constituted by molding the input member 20A using a conductive synthetic resin material or the like, and by bringing each of the conductors 41 to 43 into contact with the inner wall of the blocking portion 20a of the input member 20A.

Furthermore, the vehicle operation system 1 includes a display device 50 which displays information about the operation of the vehicle onboard device 200, and a controller 55 which sends commands to the vehicle onboard device 200 and the display device 50, based on the output signal of the motion detecting unit 40 according to the contact operation pattern to the contact operating region 21 (the first to third contact operating regions 21A₁, 21A₂ and 21A₃) of the input member 20A (FIGS. 1 and 2). The display device 50 will be described later in detail.

The circuit board 44 of the motion detecting unit 40 is electrically connected to the controller 55, and the output signal of the motion detecting unit 40 is input to the controller 55. The controller 55 detects the presence or absence of the sliding operation to the first contact operating region 21A₁, the operating direction of the sliding operation, the presence or absence of the touch operation to the second and third contact operating regions 21A₂ and 21A₃, based on the output signal. The controller 55 controls the vehicle onboard device 200 in accordance with the detection result.

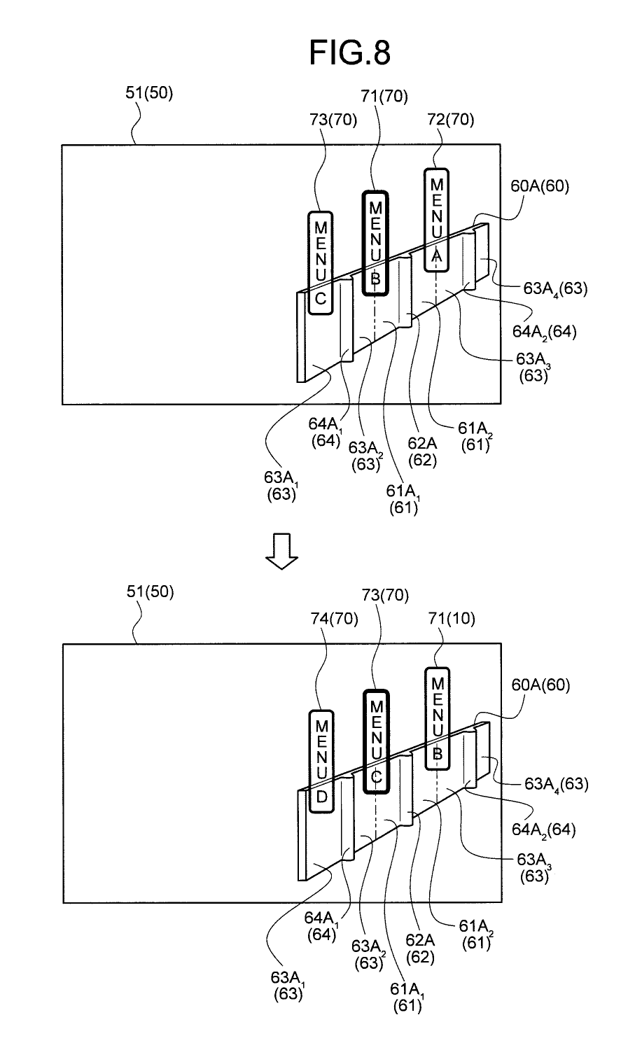

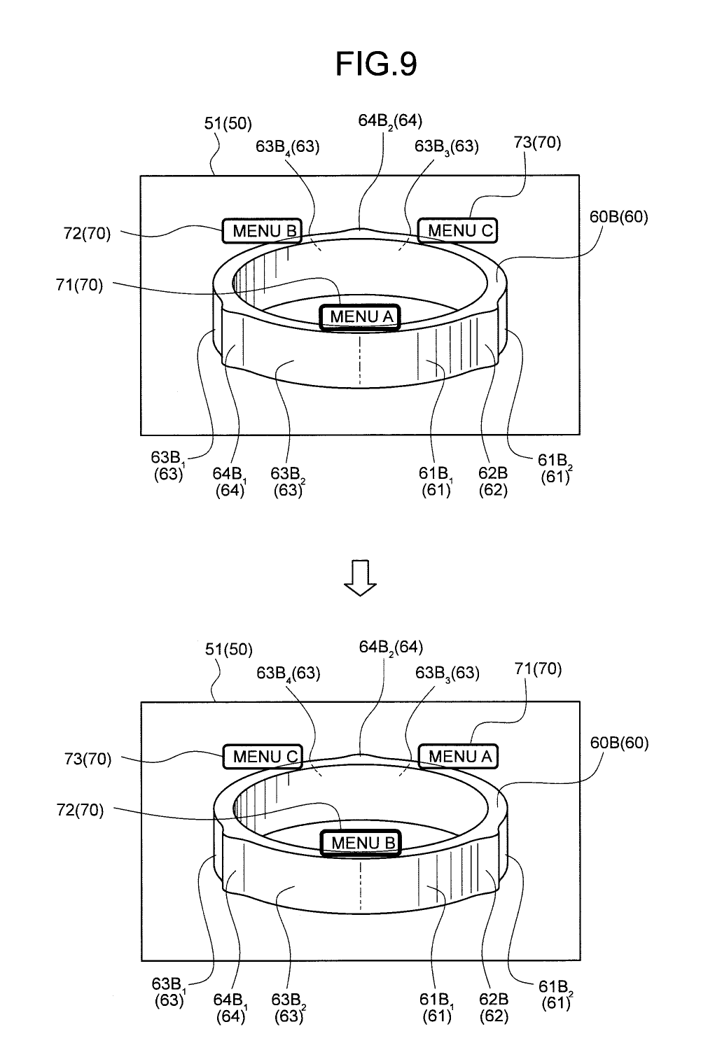

The display device 50 changes the display contents based on the detection result of the controller 55. As the display device 50, for example, a device disposed as one configuration of an instrumental device, a device disposed as a monitor of a car navigation system, and a device disposed as a display unit of a head-up display are considered. The display device 50 is provided with a region (hereinafter, referred to as a “display region”) 51 in which information about the input device 10 is displayed (FIGS. 8 and 9). The entire display unit (a section on which information and the like are displayed) of the display device 50 may be allocated to the display region 51, and some of the display unit may be allocated to the display region 51. The display information in the display region 51 is controlled by the controller 55.

For example, the controller 55 starts up the system and displays an initial screen or a screen according to the contact operation pattern in the display region 51, when detecting the contact operation to the contact operating region 21 (the first to third contact operating regions 21A₁, 21A₂ and 21A₃) of the input member 20A. For example, a virtual input section graphic 60 in which the first contact operating region 21A₁ is virtually represented, and a plurality of selection icons 70 relating to the aforementioned selecting operation function are displayed on the display region 51, so that it is possible to alternatively visually recognize the first contact operating region 21A₁ disposed at a position hard to be visible by the operator, in another location. Although the display region 51 is represented in a rectangular shape here, the display region 51 may be represented in a different shape.

The virtual input section graphic 60 has the virtual reference operation surface 61 which simulates the reference operation surface 22, and a virtual three-dimensional operation surface 62 which simulates the three-dimensional operation surface 23. The virtual reference operation surface 61 and the virtual three-dimensional operation surface 62 are alternately connected and disposed in the same way as the arrangement of the reference operation surface 22 and the three-dimensional operation surface 23. Therefore, the alternatively connecting direction of the virtual reference operation surface 61 and the virtual three-dimensional operation surface 62 is made to correspond to the operating direction of the sliding operation. For example, here, a central portion of the steering wheel 101 is made to correspond to a central portion of the display region 51. Moreover, the virtual input section graphic 60 displays, in the display region 51, the arrangement of the virtual reference operation surface 61 and the virtual three-dimensional operation surface 62 to the central portion of the display region 51, and the alternately connecting direction of the virtual reference operation surface 61 and the virtual three-dimensional operation surface 62 so that the arrangement is made to correspond to the arrangement of the first contact operating region 21A₁ to the central portion of the steering wheel 101, and the alternately connecting direction is made to correspond to the operating direction of the sliding operation.

Although the virtual input section graphic 60 may be formed to represent only a combination of the virtual reference operation surface 61 and the virtual three-dimensional operation surface 62, in addition to the combination, the virtual input section graphic 60 may have at least one set of a combination of a simulated reference operation surface 63 which simulates the virtual reference operation surface 61, and a simulated three-dimensional operation surface 64 which simulates the virtual three-dimensional operation surface 62. The simulated reference operation surface 63 and the simulated three-dimensional operation surface 64 are alternately connected and disposed in the same way as the arrangement of the virtual reference operation surface 61 and the virtual three-dimensional operation surface 62. Therefore, the alternately connecting direction of the simulated reference operation surface 63 and the simulated three-dimensional operation surface 64 is made to correspond to the operating direction of the sliding operation. The combination of the simulated reference operation surface 63 and the simulated three-dimensional operation surface 64 is disposed to be connected to the combination of the virtual reference operation surface 61 and the virtual three-dimensional operation surface 62 in the direction in which the virtual reference operation surface 61 and the virtual three-dimensional operation surface 62 are alternately connected.

The plurality of selection icons 70 is displayed on the display region 51 to be spaced apart from each other in the direction in which the virtual reference operation surface 61 and the virtual three-dimensional operation surface 62 are alternately connected. Here, the selection icon 70 for selecting the menu will be described as an example. The selection icon 70, for example, is displayed to correspond to the virtual reference operation surface 61. At that time, the selection icon 70 may be displayed to be entirely or partially superimposed with the virtual reference operation surface 61, or may be displayed on the side of the virtual reference operation surface 61 side by side. Also, when the combination of the simulated reference operation surface 63 and the simulated three-dimensional operation surface 64 is also displayed, the selection icon 70 is also displayed to correspond to the simulated reference operation surface 63. At that time, the selection icon 70 may be displayed to be entirely or partially superimposed with the simulated reference operation surface 63, or may be displayed on the side of the simulated reference operation surface 63 side by side. For example, when there is a plurality of single planes or curved surfaces made up of the virtual reference operation surface 61 and the simulated reference operation surface 63, the selection icon 70 is disposed for each of the planes or the curved surfaces. However, there is no need to necessarily match the quantity of the planes or curved surfaces and the selection icons 70. Further, the selection icon 70 may be displayed to correspond to the virtual three-dimensional operation surface 62 and the simulated three-dimensional operation surface 64. In this case, the total number of the virtual three-dimensional operation surface 62 and the simulated three-dimensional operation surface 64 may match the number of the selection icons 70, or may not match the number of the selection icons 70.

The controller 55 changes the display state of the virtual input section graphic 60 and the selection icon 70 inside the display region 51, in accordance with the operating direction of the sliding operation detected on the basis of the output signal of the motion detecting unit 40. Here, in accordance with the operating direction of the sliding operation, the virtual input section graphic 60 and the selection icon 70 are moved in the direction in which the virtual reference operation surface 61 and the virtual three-dimensional operation surface 62 are alternately connected.

Specifically, the virtual input section graphic 60 may be a graphic (a virtual input section graphic 60A) obtained by virtualizing the first contact operating region 21A₁ in a planar shape as illustrated in the upper diagram of FIG. 8, or may be a graphic (a virtual input section graphic 60B) obtained by virtualizing the first contact operating region 21A₁ in an arc-shaped surface shape as illustrated in the upper diagram of FIG. 9. Each drawing illustrates the virtual input section graphics 60A and 60B that are made to correspond to the input device 10R of the vehicle right side.

The virtual input section graphic 60A of this example is represented as a flat plate-like figure. The virtual input section graphic 60A assumes the whole or a part of one plane of the flat plate as the first contact operating region 21A₁. The virtual input section graphic 60A has a first virtual reference operation surface 61A₁ which simulates the first reference operation surface 22A₁, a second virtual reference operation surface 61A₂ which simulates the second reference operation surface 22A₂, and a virtual three-dimensional operation surface 62A interposed therebetween.

Moreover, the virtual input section graphic 60A has a first simulated reference operation surface 63A₁ which simulates the first virtual reference operation surface 61A₁, a second simulated reference operation surface 63A₂ which simulates the second virtual reference operation surface 61A₂, and a first simulated three-dimensional operation surface 64A₁ which simulates the virtual three-dimensional operation surface 62A. A combination (a first simulated contact operating region) of the first simulated reference operation surface 63A₁, the second simulated reference operation surface 63A₂ and the first simulated three-dimensional operation surface 64A₁ is displayed on the front side (the vehicle rear side) than a combination (a virtual contact operating region) of the first virtual reference operation surface 61A₁, the second virtual reference operation surface 61A₂ and the virtual three-dimensional operation surface 62A. The first virtual reference operation surface 61A₁ and the second simulated reference operation surface 63A₂ are displayed as the same plane. Further, an alternate long and two short dashes line illustrated between the first virtual reference operation surface 61A₁ and the second simulated reference operation surface 63A₂ in the drawings is a virtual line for convenience of explanation when describing the range of the first virtual reference operation surface 61A₁ and the range of the second simulated reference operation surface 63A₂.

Moreover, the virtual input section graphic 60A has a third simulated reference operation surface 63A₃ which simulates the first virtual reference operation surface 61A₁, a fourth simulated reference operation surface 63A₄ which simulates the second virtual reference operation surface 61A₂, and a second simulated three-dimensional operation surface 64A₂ which simulates the virtual three-dimensional operation surface 62A. A combination (a second simulated contact operating region) of the third simulated reference operation surface 63A₃, the fourth simulated reference operation surface 63A₄ and the second simulated three-dimensional operation surface 64A₂ is displayed on the rear side (the vehicle front side) than the combination (the virtual contact operating region) of the first virtual reference operation surface 61A₁, the second virtual reference operation surface 61A₂ and the virtual three-dimensional operation surface 62A. An alternate long and two short dashes line illustrated between the second virtual reference operation surface 61A₂ and the third simulated reference operation surface 63A₃ is a virtual line for convenience of explanation when describing a range of the second virtual reference operation surface 61A₂ and a range of the third simulated reference operation surface 63A₃.

In the display region 51 on which the virtual input section graphic 60A is displayed, a first selection icon 71 made to correspond to the first virtual reference operation surface 61A₁ and the second simulated reference operation surface 63A₂, and a second selection icon 72 made to correspond to the second virtual reference operation surface 61A₂ and the third simulated reference operation surface 63A₃ are displayed. Here, the first selection icon 71 is assumed to be selected, and the first selection icon 71 is emphatically displayed than the second and third selection icons 72 and 73. In this case, a third selection icon 73 made to correspond to the first simulated reference operation surface 63A₁ is displayed on the display region 51. In this case, the second selection icon 72 and the third selection icon 73 are represented as next selections of the first selection icon 71.

The controller 55 moves the virtual input section graphic 60A and the first to third selection icons 71 to 73 in a direction (a vehicle front-rear direction along the plane of the virtual input section graphic 60A) in which the virtual reference operation surface 61 (the first and second virtual reference operation surfaces 61A₁ and 61A₂) and the virtual three-dimensional operation surface 62A are alternately connected, in accordance with the operating direction of the sliding operation detected on the basis of the output signal of the motion detecting unit 40.

For example, when the operator desires switching from the first selection icon 71 to the third selection icon 73 at the sight of the display region 51, the operator performs the sliding operation directed toward the vehicle front side from the vehicle rear side with respect to the first contact operating region 21A₁. The controller 55 moves the virtual input section graphic 60A and the first to third selection icons 71 to 73 toward the vehicle front side from the vehicle rear side, in accordance with the operating direction of the sliding operation (a bottom diagram of FIG. 8).

Accordingly, in the virtual input section graphic 60A, the virtual contact operating region before the sliding operation (a combination of the first virtual reference operation surface 61A₁, the second virtual reference operation surface 61A₂ and the virtual three-dimensional operation surface 62A) moves to the location of the second simulated contact operating region before the sliding operation (a combination of the third simulated reference operation surface 63A₃, the fourth simulated reference operation surface 63A₄ and the second simulated three-dimensional operation surface 64A₂), and is represented as a new second simulated contact operating region. Further, the first simulated contact operating region before the sliding operation (a combination of the first simulated reference operation surface 63A₁, the second simulated reference operation surface 63A₂ and the first simulated three-dimensional operation surface 64A₁) moves to a location of the virtual contact operating region before the sliding operation, and is represented as a new virtual contact operating region. At that time, the second simulated contact operating region before the sliding operation, for example, gradually disappears, while moving to the vehicle front side. Meanwhile, in the location where the first simulated contact operating region before the sliding operation is present, a new first simulated contact operating region gradually appears toward the vehicle front side from the vehicle rear side.

Also, in the first to third selection icons 71 to 73, the first selection icon 71 before the sliding operation moves to the location of the second selection icon 72 before the sliding operation, and the third selection icon 73 before the sliding operation moves to the location of the first selection icon 71 before the sliding operation. At that time, the second selection icon 72 before the sliding operation, for example, disappears, while moving to the vehicle front side. Meanwhile, in the location where the third selection icon 73 before the sliding operation is present, for example, a fourth selection icon 74 appears toward the vehicle front side from the vehicle rear side.

The operator can visually grasp the movement on the plane of the virtual three-dimensional operation surface 62A of the virtual input section graphic 60A interlocked with the sliding operation, as that corresponding to the three-dimensional operation surface 23 of the input member 20A which is recognized by the tactile sense accompanied with the sliding operation.

Next, the virtual input section graphic 60B will be described.

The virtual input section graphic 60B is used when the sliding operation of the first contact operating region 21A₁ is assumed as the operation along arc-shaped circumferential direction. Therefore, the virtual reference operation surface 61 of the virtual input section graphic 60B is formed in an arc-shape which is made to correspond to the circumferential direction. For example, the virtual input section graphic 60B can be illustrated as a three-dimensional figure which represents a disc, a fan body, an annular body or a part of the annular body. In this case, all or a part of the outer circumferential surface can be assumed as the first contact operating region 21A₁. Moreover, all or a part of the inner circumferential surface of the virtual input section graphic 60B can be assumed as the first contact operating region 21A₁, in the case of the three-dimensional figure which represents a part of the annular body. Here, the virtual input section graphic 60B of the annular body will be described as an example.

The virtual input section graphic 60B has, on the outer circumferential surface thereof, a first virtual reference operation surface 61B₁ that simulates the first reference operation surface 22A₁, a second virtual reference operation surface 61B₂ which simulates the second reference operation surface 22A₂, and a virtual three-dimensional operation surface 62B which is interposed therebetween.

Moreover, the virtual input section graphic 60B has, on the outer circumferential surface thereof, a first simulated reference operation surface 63B₁ that simulates the first virtual reference operation surface 61B₁, a second simulated reference operation surface 63B₂ that simulates the second virtual reference operation surface 61B₂, and a first simulated three-dimensional operation surface 64B₁ that simulates the virtual three-dimensional operation surface 62B. A combination (a first simulated contact operating region) of the first simulated reference operation surface 63B₁, the second simulated reference operation surface 63B₂ and the first simulated three-dimensional operation surface 64B₁ is displayed on an opposite side in the vehicle width direction as viewed from the central portion of the steering wheel 101, with respect to a combination (a virtual contact operating region) of the first virtual reference operation surface 61B₁, the second virtual reference operation surface 61B₂ and the virtual three-dimensional operation surface 62B. In this example, the virtual contact operating region (the combination of the first virtual reference operation surface 61B₁, the second virtual reference operation surface 61B₂ and the virtual three-dimensional operation surface 62B) is displayed on the vehicle right side, and the first simulated contact operating region (the combination of the first simulated reference operation surface 63B₁, the second simulated reference operation surface 63B₂ and the first simulated three-dimensional operation surface 64B₁) is displayed on the vehicle left side. The first virtual reference operation surface 61B₁ and the second simulated reference operation surface 63B₂ are displayed as the same arc-shaped surface. Furthermore, an alternate long and two short dashes line illustrated between the first virtual reference operation surface 61B₁ and the second simulated reference operation surface 63B₂ in the drawing is a virtual line for convenience of explanation when describing the range of the first virtual reference operation surface 61B₁ and the range of the second simulated reference operation surface 63B₂ (the same is applied hereinafter).

Furthermore, the virtual input section graphic 60B has, between the virtual contact operating region and the first simulated contact operating region on the outer circumferential surface, a combination (a second simulated contact operating region) of a third simulated reference operation surface 63B₃ which simulates the first virtual reference operation surface 61B₁, a fourth simulated reference operation surface 63B₄ which simulates the second virtual reference operation surface 61B₂, and a second simulated three-dimensional operation surface 64B₂ which simulates the virtual three-dimensional operation surface 62B. The second simulated contact operating region (the combination of the third simulated reference operation surface 63B₃, the fourth simulated reference operation surface 63B₄ and the second simulated three-dimensional operation surface 64B₂) is displayed on the vehicle rear side. The second virtual reference operation surface 61B₂ and the third simulated reference operation surface 63B₃ are displayed as the same arc-shaped surface. Further, the first simulated reference operation surface 63B₁ and the fourth simulated reference operation surface 63B₄ are displayed as the same arc-shaped surface.

In the display region 51 on which the virtual input section graphic 60B is displayed, the first selection icon 71 made to correspond to the first virtual reference operation surface 61B₁ and the second simulated reference operation surface 63B₂, the second selection icon 72 made to correspond to the first simulated reference operation surface 63B₁ and the fourth simulated reference operation surface 63B₄, and the third selection icon 73 made to correspond to the second virtual reference operation surface 61B₂ and the third simulated reference operation surface 63B₃ are displayed. That is, the first selection icon 71, the second selection icon 72 and the third selection icon 73 are disposed to be apart from one another along the circumferential direction of the virtual reference operation surface 61 (the first and second virtual reference operation surfaces 61B₁ and 61B₂). Here, the first selection icon 71 is assumed to be selected, and the first selection icon 71 is emphatically displayed than the second and third selection icons 72 and 73. In this case, the second selection icon 72 and the third selection icon 73 are represented as the next selections of the first selection icon 71.

The controller 55 moves the virtual input section graphic 60B and the first to third selection icons 71 to 73 in a direction (a circumferential direction along the outer circumferential surface of the virtual input section graphic 60B) in which the virtual reference operation surface 61 (the first and second virtual reference operation surfaces 61B₁ and 61B₂) and the virtual three-dimensional operation surface 62B are alternately connected, in accordance with the operating direction of the sliding operation detected on the basis of the output signal of the motion detecting unit 40.

For example, when the operator desires switching from the first selection icon 71 to the third selection icon 73 as in the previous example, the operator performs the sliding operation on the first contact operating region 21A₁ directed toward the vehicle front side from the vehicle rear side. The controller 55 rotates the virtual input section graphic 60B and the first to third selection icons 71 to 73 in a counter-clockwise direction along the outer circumferential surface of the virtual input section graphic 60B, in accordance with the operating direction of the sliding operation (a lower diagram of FIG. 9).

Accordingly, in the virtual input section graphic 60B, the virtual contact operating region before the sliding operation (a combination of the first virtual reference operation surface 61B₁, the second virtual reference operation surface 61B₂ and the virtual three-dimensional operation surface 62B) moves to the location of the second simulated contact operating region before the sliding operation (a combination of the third simulated reference operation surface 63B₃, the fourth simulated reference operation surface 63B₄ and the second simulated three-dimensional operation surface 64B₂), and is represented as a new second simulated contact operating region. Further, the second simulated contact operating region before the sliding operation moves to a location of the first simulated contact operating region before the sliding operation (a combination of the first simulated reference operation surface 63B₁, the second simulated reference operation surface 63B₂ and the first simulated three-dimensional operation surface 64B₁), and is represented as a new first simulated contact operating region. Further, the first simulated contact operating region before the sliding operation moves to the location of the virtual contact operating region before the sliding operation, and is represented as a new virtual contact operating region.

Also, in regard to the first to third selection icons 71 to 73, the first selection icon 71 before the sliding operation moves to the location of the third selection icon 73 before the sliding operation, the third selection icon 73 before the sliding operation moves to the location of the second selection icon 72 before the sliding operation, and the second selection icon 72 before the sliding operation moves to the location of the first selection icon 71 before the sliding operation.

The operator can visually grasp the rotation in the circumferential direction of the virtual input section graphic 60B interlocked with the sliding operation, and the movement in the circumferential direction of the virtual three-dimensional operation surface 62B, as that corresponding to the three-dimensional operation surface 23 of the input member 20A which is recognized by the tactile sense accompanied with the sliding operation.

In this way, according to the vehicle operation system 1 of the present embodiment, the operator can obtain information on the first contact operating region 21A₁ (mainly, the three-dimensional operation surface 23) during the sliding operation by tactile sense, and can visually obtain information on the virtual contact operating region (mainly, the virtual three-dimensional operation surface 62) corresponding to the first contact operating region 21A₁ during the sliding operation (mainly, the three-dimensional operation surface 23). Therefore, in the vehicle operation system 1, the operational feeling of the first contact operating region 21A₁ disposed at a position hard to be visible is improved.

Here, it is desirable that the virtual three-dimensional operation surface 62 be emphatically displayed. For example, as in the virtual input section graphic 60B illustrated in FIG. 9, the virtual three-dimensional operation surface 62B is emphatically displayed, by adjusting the direction of the irradiated beam (a virtual beam that is not displayed on the display region 51) with respect to the virtual input section graphic 60B, and by emphasizing a shade in the virtual input section graphic 60B. Further, the virtual three-dimensional operation surface 62 can also be emphatically displayed, by changing the color to other parts of the virtual input section graphic 60B, or by lighting or blinking the peripheral edge. By emphatically displaying the virtual three-dimensional operation surface 62 in this way, the vehicle operation system 1 of the present embodiment can enhance the degree of recognition using the visual sense of the virtual three-dimensional operation surface 62. Accordingly, it is possible to further improve the operational feeling of the first contact operating region 21A₁.

Further, the vehicle operation system 1 of the present embodiment may further improve the operational feeling of the first contact operating region 21A₁, by providing a visual stimulus to the operator as follows, in the display region 51 before and after the sliding operation (between the upper diagram of FIG. 8 and the lower diagram of FIG. 8).

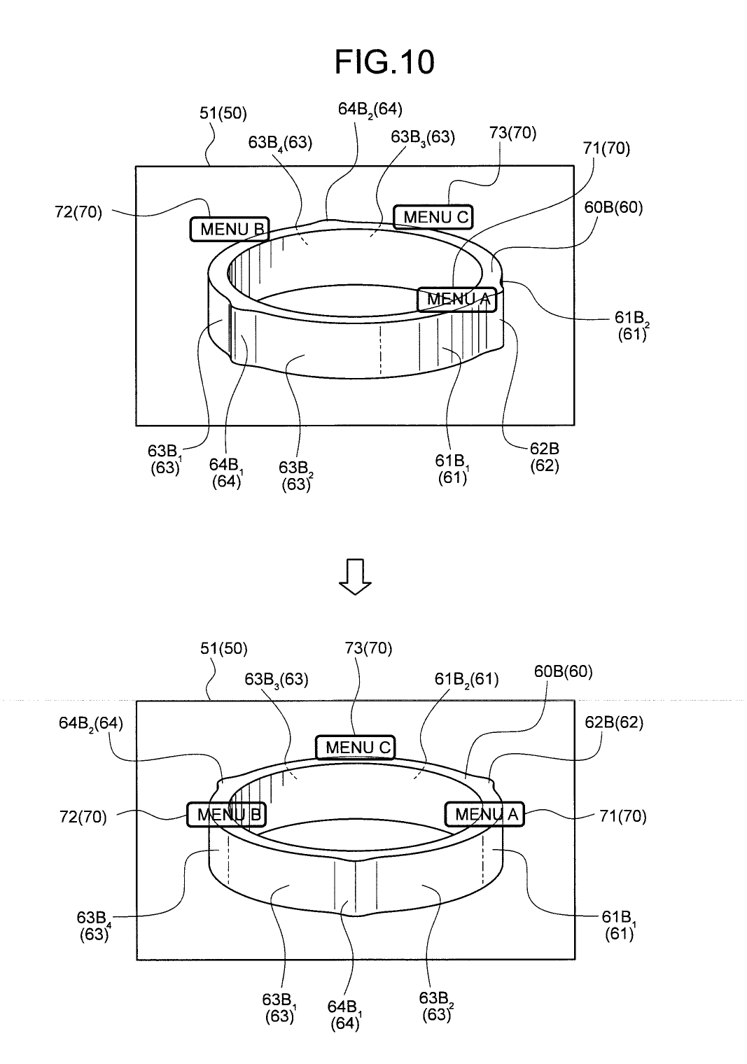

For example, when the operator performs the sliding operation illustrated above in the upper diagram of FIG. 8, the controller 55 rotates the virtual input section graphic 60B and the first to third selection icons 71 to 73 in the circumferential direction, but at that time, the amount of rotation of the first selection icon 71 during selection is set to be larger than the amount of rotation of second and third selection icons 72 and 73 (the upper diagram of FIG. 10). At that time, the controller 55 cancels the emphasized display of the first selection icon 71. Thus, the operator can visually recognize that the personally performed sliding operation corresponds to the switching to the second selection icon 72 from the first selection icon 71 again.

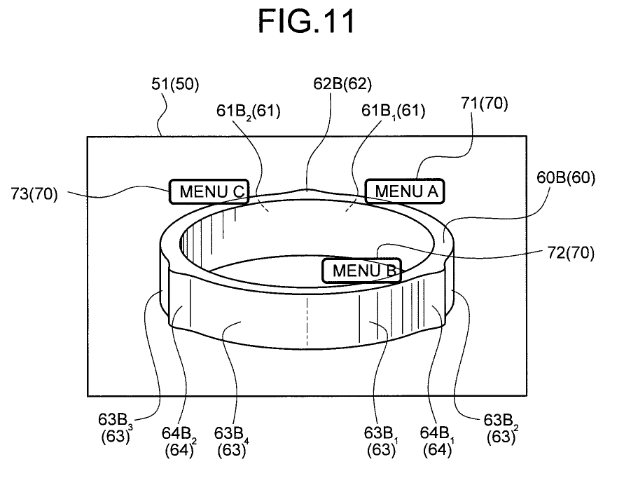

Further, the controller 55 increases the amount of rotation of the second and third selection icons 72 and 73, while suppressing the amount of rotation of the first selection icon 71, and rotates the virtual input section graphic 60B and the first to third selection icons 71 to 73 to a substantially intermediate position in the circumferential direction (about 60 degrees from the initial position before the sliding operation in this example) (a lower diagram of FIG. 10). After that, the controller 55 moves the second selection icon 72 before the sliding operation to the location of the first selection icon 71 before the sliding operation, by rotating the virtual input section graphic 60B and the first to third selection icons 71 to 73 at the substantially equal magnitude in the circumferential direction. At that time, the controller 55 returns the second selection icon 72 to the location of the first selection icon 71 before the sliding operation (the lower diagram of FIG. 8), after further moving the second selection icon 72 than the location of the first selection icon 71 before the sliding operation (that is, after making the second selection icon 72 overrun) (FIG. 11). From this point, the operator can also visually recognize that the personally performed sliding operation corresponds to the switching to the next second selection icon 72 from the first selection icon 71.

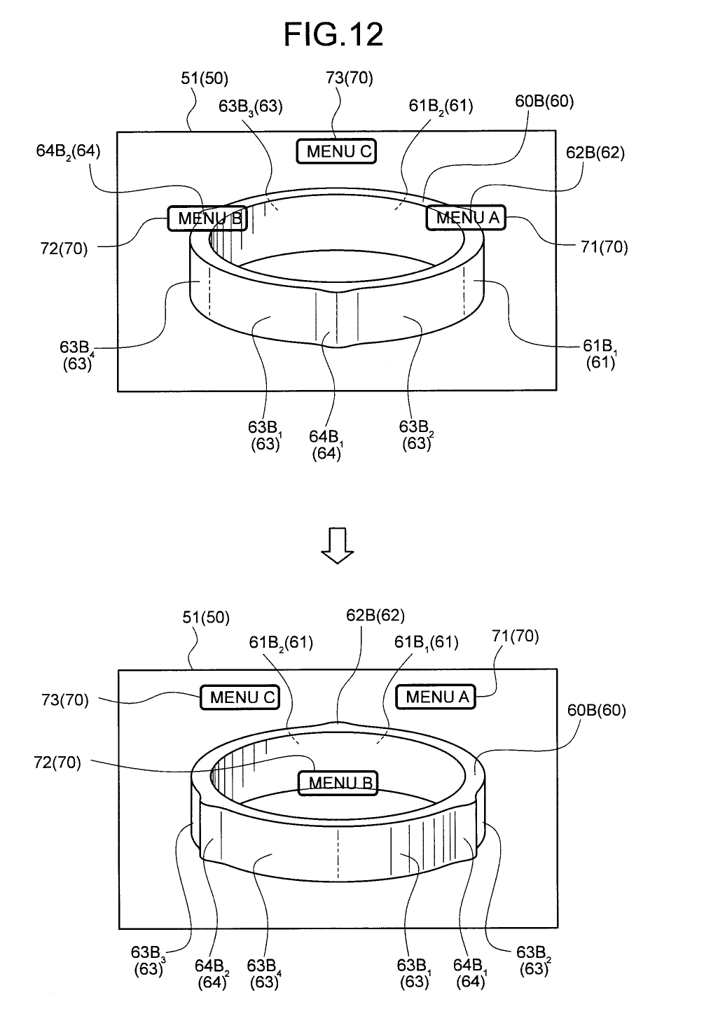

Further, the controller 55 may move the first to third selection icons 71 to 73 in a direction different from the circumferential direction (here, raise them to the vehicle top), as illustrated in the upper diagram of FIG. 12, after rotating the virtual input section graphic 60B and the first to third selection icons 71 to 73 to a substantially intermediate position in the circumferential direction (the lower diagram of FIG. 10). In this case, after rotating the virtual input section graphic 60B and the first to third selection icons 71 to 73 to the rotation completion position in the circumferential direction (the lower diagram of FIG. 12), while moving the first to the third selection icons 71 to 73 in the different direction, the controller 55 returns the first to third selection icons 71 to 73 by an amount of movement in the different direction (here, lower them to the vehicle bottom), and moves the second selection icon 72 before the sliding operation to the location of the first selection icon 71 before the sliding operation (the lower diagram of FIG. 8). Further, after moving the first to third selection icons 71 to 73 in the different direction (the upper diagram of FIG. 12), the controller 55 may move the second selection icon 72 before the sliding operation to the location of the first selection icon 71 before the sliding operation, while returning the first to third selection icons 71 to 73 by the amount of movement (while lower them to the vehicle bottom), and while rotating the virtual input section graphic 60B and the first to third selection icons 71 to 73 in the circumferential direction.

As illustrated above, the vehicle operation system 1 of the present embodiment allows the operator to visually grasp the movement of the virtual three-dimensional operation surface 62 of the virtual input section graphic 60 interlocked with the sliding operation, as that corresponding to the three-dimensional operation surface 23 of the input member 20A which is recognized by the tactile sense accompanied with the sliding operation. The vehicle operation system 1 can improve the operational feeling of the first contact operating region 21A₁ disposed at a position hard to be visible, by allowing the operator to recognize the information of both of the tactile sense and the visual sense about the three-dimensional operation surface 23.

Meanwhile, the vehicle operation system 1 of the present embodiment may display each information about the input member 20 of the vehicle left side and the input member 20 of the vehicle right side on a single screen, with respect to the display region 51. In this case, for example, a part of an annular body, such as being obtained by dividing the annular virtual input section graphic 60B into two parts of the vehicle left side and the vehicle right side at the central portion of the display region 51, is displayed on the display region 51. Further, in the virtual input section graphic according to a part of the annular body of the left side of vehicle, the virtual contact operating region that simulates the first contact operating region 21A₁ of the input member 20 of the vehicle left side, or the virtual contact operating region and the simulated contact operating region that simulates the virtual contact operating region are displayed. Further, in the virtual input section graphic according to a part of the annular body of the vehicle right side, the virtual contact operating region that simulates the first contact operating region 21A₁ of the input member 20 of the vehicle right side, or the virtual contact operating region and the simulated contact operating region that simulates the virtual contact operating region are displayed.

### First Modified Example

The present modified example is configured so that the input member 20 is replaced with an input member 20B from the input member 20A in the vehicle operation system 1 of the embodiment described above. In the vehicle operation system 1 of the present modified example, the controller 55 performs the control similar to the embodiment.

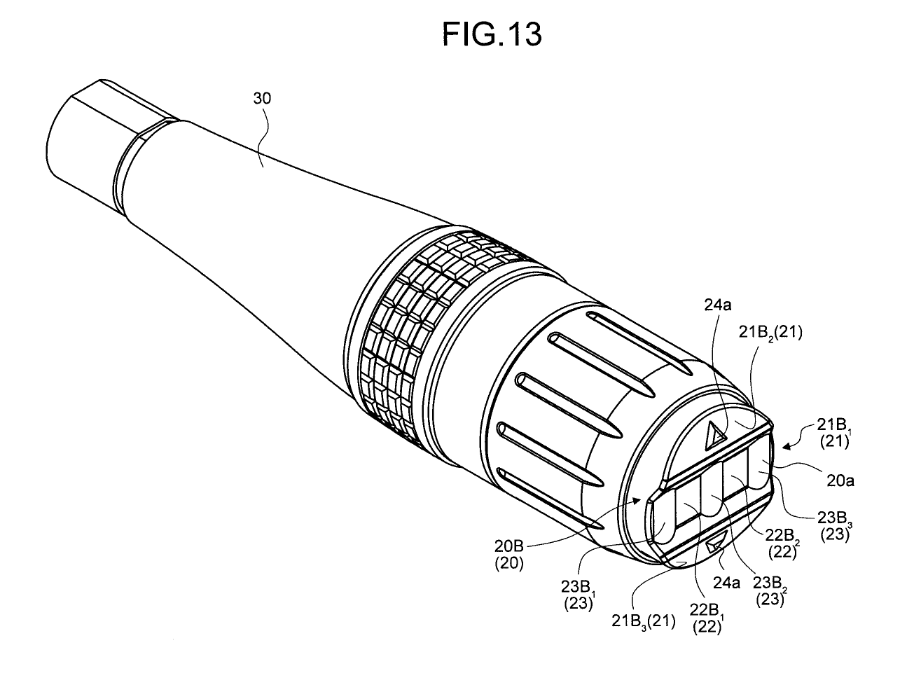

The input member 20B includes three contact operating regions 21 (first to third contact operating regions 21B₁, 21B₂ and 21B₃), as in the input member 20A of the embodiment (FIG. 13). The first contact operating region 21B₁ is equivalent to the first contact operating region 21A₁ of the embodiment, and at least a sliding operation is allocated to the first contact operating region 21B₁. The second and third contact operating regions 21B₂ and 21B₃ are equivalent to the second and third contact operating regions 21A₂ and 21A₃ of the embodiment, and the touch operation is allocated to the second and third contact operating regions 21B₂ and 21B₃.

The first contact operating region 21B₁ has two reference operation surfaces 22 (first and second reference operation surfaces 22B₁ and 22B₂), and three three-dimensional operation surfaces 23 (first to third three-dimensional operation surfaces 23B₁, 23B₂ and 23B₃). In this example, along the operating direction of the sliding operation, the reference operation surface 22 and the three-dimensional operation surface 23 are alternately disposed in the order of the first three-dimensional operation surface 23B₁, the first reference operation surface 22B₁, the second three-dimensional operation surface 23B₂, the second reference operation surface 22B₂, and the third three-dimensional operation surface 23B₃. The first to third three-dimensional operation surfaces 23B₁, 23B₂ and 23B₃ of this example are protruding operation surfaces which protrude to the side closer the fingers of the operator than the first and second reference operation surfaces 22B₁ and 22B₂.

In the first contact operating region 21B₁, a conductor (not illustrated) provided for each of the first and second reference operation surfaces 22B₁ and 22B₂, and a conductor (not illustrated) provided for each of the first to third three-dimensional operation surfaces 23B₁, 23B₂ and 23B₃ are disposed to be spaced apart from one another.

In the virtual input section graphic (not illustrated) displayed on the display region 51 of this modified example, as in the example of the embodiment, a virtual contact operating region which simulates the first contact operating region 21B₁ is provided. Although it is not illustrated, the virtual contact operating region is formed by a combination of a protruding first virtual three-dimensional operation surface that simulates the first three-dimensional operation surface 23B₁, a first virtual reference operation surface that simulates the first reference operation surface 22B₁, a protruding second virtual three-dimensional operation surface that simulates the second three-dimensional operation surface 23B₂, a second virtual reference operation surface that simulates the second reference operation surface 22B₂, and a protruding third virtual three-dimensional operation surface that simulates the third three-dimensional operation surface 23B₃.

As in the example of the embodiment, at least one simulated contact operating region which simulates the virtual contact operating region may be provided in the virtual input section graphic. Although it is not illustrated, the simulated contact operating region is formed by a combination of a protruding first simulated three-dimensional operation surface which simulates the first virtual three-dimensional operation surface, a first simulated reference operation surface which simulates the first virtual reference operation surface, a protruding second simulated three-dimensional operation surface which simulates the second virtual three-dimensional operation surface, a second simulated reference operation surface which simulates the second virtual reference operation surface, and a protruding third simulated three-dimensional operation surface which simulates the third virtual three-dimensional operation surface.

In the vehicle operation system 1 of the present modified example, the operator can visually grasp the movement of the first to third virtual three-dimensional operation surfaces of the virtual input section graphic interlocked with the sliding operation, as that corresponding to the first to third three-dimensional operation surfaces 23B₁, 23B₂ and 23B₃ of the input member 20B which is recognized by the tactile sense accompanied with the sliding operation. The vehicle operation system 1 can improve the operational feeling of the first contact operating region 21B₁ disposed at a position hard to be visible, by making the operator recognize information of both of the tactile sense and the visual sense about the first to third three-dimensional operation surfaces 23B₁, 23B₂ and 23B₃.

Further, in order to make the operator recognize that the fingers touch the second and third contact operating regions 21B₂ and 21B₃, a protruding portion 24a made to protrude from the surfaces of the second and third contact operating regions 21B₂ and 21B₃ is provided in the second and third contact operating regions 21B₂ and 21B₃ of this modified example.

### Second Modified Example

This modified example is configured so that the input member 20 is replaced with an input member 20C from the input member 20A in the vehicle operation system 1 of the embodiment described above. In the vehicle operation system 1 of the present modified example, the control similar to the embodiment of the controller 55 is performed.

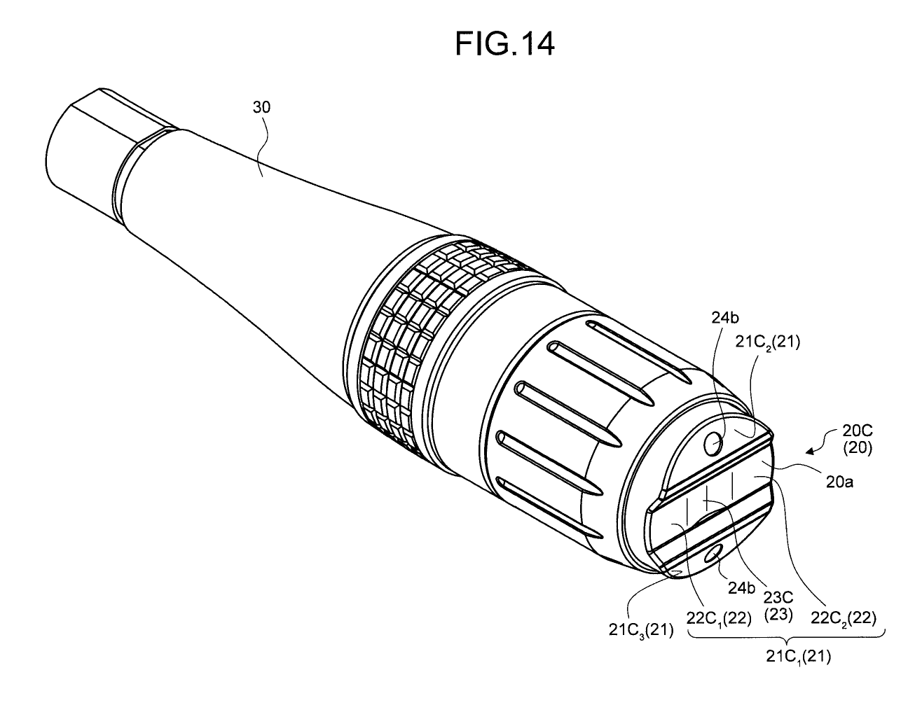

The input member 20C includes three contact operating regions 21 (first to third contact operating regions 21C₁, 21C₂ and 21C₃), as in the input member 20A of the embodiment (FIG. 14). The first contact operating region 21C₁ is equivalent to the first contact operating region 21A₁ of the embodiment, and at least the sliding operation is allocated to the first contact operating region 21C₁. The second and third contact operating regions 21C₂ and 21C₃ are equivalent to the second and third contact operating regions 21A₂ and 21A₃ of the embodiment, and the touch operation is allocated to the second and third contact operating regions 21C₂ and 21C₃.

The first contact operating region 21C₁ has two reference operation surfaces 22 (first and second reference operation surfaces 22C₁ and 22C₂), and a single three-dimensional operation surface 23C interposed between the reference operation surfaces 22. In this example, the first reference operation surface 22C₁, the three-dimensional operation surface 23C and the second reference operation surface 22C₂ are alternately disposed along the operating direction of the sliding operation. The three-dimensional operation surface 23C of this example is a recessed operation surface which is recessed deeper than the first and second reference operation surfaces 22C₁ and 22C₂.

In the first contact operating region 21C₁, a conductor (not illustrated) provided for each of the first and second reference operation surfaces 22C₁ and 22C₂, and a conductor (not illustrated) for the three-dimensional operation surface 23C are disposed to be spaced apart from each other.

Same as in the example of the embodiment, a virtual contact operating region which simulates the first contact operating region 21C₁ is provided in the virtual input section graphic (not illustrated) displayed on the display region 51 of this modified example. Although it is not illustrated, the virtual contact operating region is formed by a combination of a first virtual reference operation surface which simulates the first reference operation surface 22C₁, a recessed virtual three-dimensional operation surface which simulates the three-dimensional operation surface 23C, and a second virtual reference operation surface which simulates the second reference operation surface 22C₂.

As in the example of the embodiment, in the virtual input section graphic, at least one simulated contact operating region which simulates the virtual contact operating region may be provided. Although it is not illustrated, the simulated contact operating region is formed by a combination of a first simulated reference operation surface which simulates the first virtual reference operation surface, a recessed simulated three-dimensional operation surface which simulates the virtual three-dimensional operation surface, and a second simulated reference operation surface which simulates the second virtual reference operation surface.

In the vehicle operation system 1 of the present modified example, the operator can visually grasp the movement of the virtual three-dimensional operation surface of the virtual input section graphic interlocked with the sliding operation, as that corresponding to the three-dimensional operation surface 23C of the input member 20C which is recognized by the tactile sense accompanied with the sliding operation. The vehicle operation system 1 can improve the operational feeling of the first contact operating region 21C₁ disposed at a position hard to be visible, by making the operator recognize information of both of the tactile sense and the visual sense about the three-dimensional operation surface 23C.

Further, in order to make the operator recognize that the fingers touch the second and third contact operating regions 21C₂ and 21C₃, a recessed portion 24b which is recessed from the surfaces of the second and third contact operating regions 21C₂ and 21C₃ is provided in the second and third contact operating regions 21C₂ and 21C₃ of this modified example.

### Third Modified Example

The connecting member (the longitudinal member) 30 of the above-described embodiments and first and second modified examples has been described as a member that connects the input member 20 and the vehicle body side. In this modified example, the connecting member 30 is used as a housing of a lever switch in the lever operation unit. The lever operation unit is used to operate the vehicle onboard device 200. The lever operation unit, for example, is represented by a turn signal lever or the like. That is, the vehicle operation system 2 of this modified example is configured by coexistence of the system configuration relating to the input member 20 of the embodiment and first and second modified examples, and such a lever operation unit.

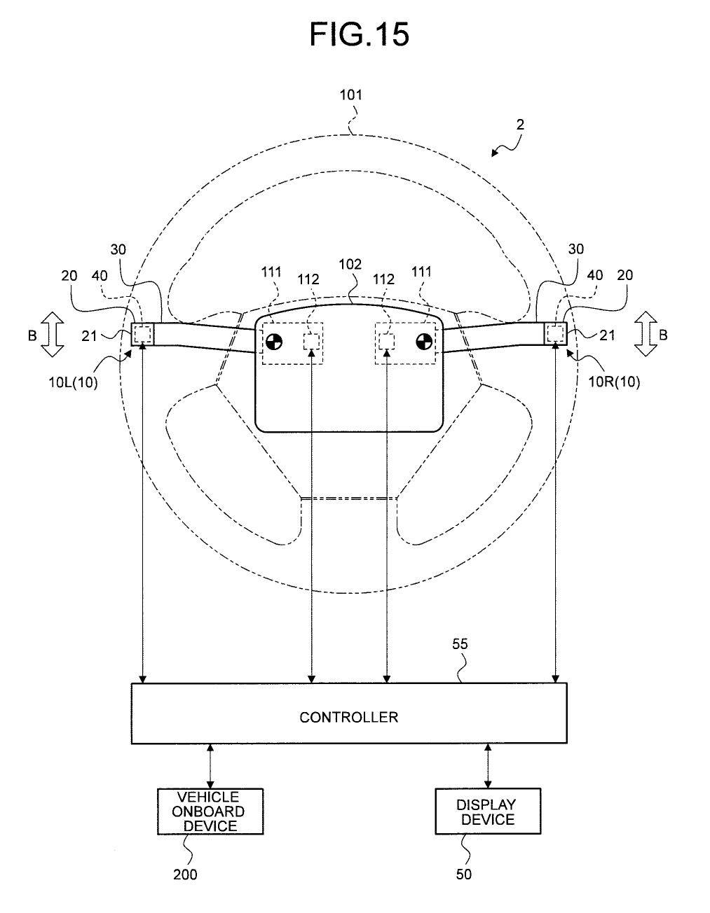

The connecting member 30 of this modified example is tiltably supported by a support unit 111 which is fixed inside a steering column 102 (FIG. 15). The support unit 111 is configured so that the tilting operation based on an end portion of the steering column 102 side of the connecting member 30 as a fulcrum is freely performed. The connecting member 30 of this example can perform a tilting operation toward the vehicle front side, a tilting operation toward the vehicle rear side, a tilting operation in a clockwise direction toward one circumferential direction, and a tilting operation in a counter-clockwise direction toward the other circumferential direction, based on a neutral position as a base point. At least one vehicle onboard device 200, and at least one function of the vehicle onboard device 200 are allocated to each operating direction of the connecting member 30.

Here, the support unit 111 may be configured to return the connecting member 30 to the neutral position by the spring force or the like, after tilting the connecting member 30 in one operating direction from the neutral position, and the support unit 111 may be configured to return the connecting member 30 to the neutral position with the operator's hand, after tilting the connecting member 30 in one operating direction from the neutral position. In the latter case, the support unit 111 is configured so that the tilting operation of the connecting member 30 of at least one stage is performed.

The lever operation unit is provided with a lever operation detecting unit 112 which detects the tilting direction in the tilting operation of the connecting member 30. The lever operation detecting unit 112 transmits an output signal according to the tilting direction of the connecting member 30 to the controller 55. The controller 55 can detect the operating direction of the connecting member 30 performed by the operator, based on the output signal. The controller 55 performs the control of the vehicle onboard device 200 in accordance with the operating direction.

The vehicle operation system 2 of the present modified example can also obtain the same effects as those described in the embodiment and first and second modified examples, with such a configuration.

The vehicle operation system according to the present embodiment can allow an operator to recognize the three-dimensional operation surface of the input member by tactile sense, along with the sliding operation. Further, the vehicle operation system can allow an operator to visually grasp a movement of a virtual three-dimensional operation surface of a virtual input section graphic interlocked with the sliding operation, as that corresponding to the three-dimensional operation surface which is recognized by the tactile sense. The vehicle operation system can improve the operational feeling of the contact operating region disposed at a position hard to be visible, by allowing an operator to recognize information of both of the tactile sense and the visual sense about the three-dimensional operation surface.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle operation system comprising:
an input device including at least one contact operating region and a motion detecting unit, the one contact operating region being disposed on a vehicle front side than a steering wheel and at a position which is operable by an operator without releasing his hand from the steering wheel, and being performed a contact operation with fingers thereto when the operator operates a vehicle onboard device, the motion detecting unit being capable of detecting a contact operation pattern of the operator to the contact operating region;
a display device that displays information on an operation of the vehicle onboard device; and
a controller configured to send a command to the vehicle onboard device and the display device, based on an output signal of the motion detecting unit according to the contact operation pattern, wherein
the contact operating region has at least one reference operation surface, has at least one of a protruding operation surface protruding to the reference operation surface and a recessed operation surface recessed to the reference operation surface, as a three-dimensional operation surface, and sets a direction in which the reference operation surface and the three-dimensional operation surface are alternately connected, as an operating direction of a sliding operation of an operator's finger,
a virtual input section graphic and a plurality of selection icons are displayed on a display region of the display device, the virtual input section graphic having a virtual reference operation surface which simulates the reference operation surface, and a virtual three-dimensional operation surface which simulates the three-dimensional operation surface, the plurality of selection icons being related to the operation of the vehicle onboard devices disposed to be spaced apart from each other in a direction in which the virtual reference operation surface and the virtual three-dimensional operation surface are alternately connected, and
the controller moves the virtual input section graphic and the selection icon in a direction in which the virtual reference operation surface and the virtual three-dimensional operation surface are alternately connected, in accordance with the operating direction of the sliding operation detected on the basis of the output signal of the motion detecting unit.

2. The vehicle operation system according to claim 1, wherein
a central portion of the steering wheel and a central portion of the display region are made to correspond to each other, and the virtual input section graphic is displayed on the display region in such a manner that an arrangement of the virtual reference operation surface and the virtual three-dimensional operation surface to the central portion of the display region is made to correspond to an arrangement of the contact operating region to the central portion of the steering wheel, and the direction in which the virtual reference operation surface and the virtual three-dimensional operation surface are alternately connected is made to correspond to the operating direction of the sliding operation.

3. The vehicle operation system according to claim 1, wherein
the virtual three-dimensional operation surface is emphatically displayed.

4. The vehicle operation system according to claim 2, wherein
the virtual three-dimensional operation surface is emphatically displayed.

5. The vehicle operation system according to claim 1, wherein
when the sliding operation to the contact operating region is assumed as an operation along an arc-shaped circumferential direction, the virtual input section graphic having the arc-shaped virtual reference operation surface and the virtual three-dimensional operation surface made to correspond to the circumferential direction, and a plurality of selection icons disposed to be apart from one another along the circumferential direction of the virtual reference operation surface are displayed on the display region, and
the controller rotates the virtual input section graphic and the selection icons in the circumferential direction of the virtual reference operation surface, in accordance with the operating direction of the sliding operation which is detected on the basis of the output signal of the motion detecting unit.

6. The vehicle operation system according to claim 2, wherein
when the sliding operation to the contact operating region is assumed as an operation along an arc-shaped circumferential direction, the virtual input section graphic having the arc-shaped virtual reference operation surface and the virtual three-dimensional operation surface made to correspond to the circumferential direction, and a plurality of selection icons disposed to be apart from one another along the circumferential direction of the virtual reference operation surface are displayed on the display region, and
the controller rotates the virtual input section graphic and the selection icons in the circumferential direction of the virtual reference operation surface, in accordance with the operating direction of the sliding operation which is detected on the basis of the output signal of the motion detecting unit.

7. The vehicle operation system according to claim 3, wherein
when the sliding operation to the contact operating region is assumed as an operation along an arc-shaped circumferential direction, the virtual input section graphic having the arc-shaped virtual reference operation surface and the virtual three-dimensional operation surface made to correspond to the circumferential direction, and a plurality of selection icons disposed to be apart from one another along the circumferential direction of the virtual reference operation surface are displayed on the display region, and
the controller rotates the virtual input section graphic and the selection icons in the circumferential direction of the virtual reference operation surface, in accordance with the operating direction of the sliding operation which is detected on the basis of the output signal of the motion detecting unit.

8. The vehicle operation system according to claim 5, wherein
the reference operation surface is formed in an arc shape in accordance with the virtual reference operation surface.

9. The vehicle operation system according to claim 5, wherein
the virtual input section graphic is a three-dimensional figure which represents a disc, a fan body, an annular body or a part of the annular body, and the virtual input section graphic has the virtual reference operation surface and the virtual three-dimensional operation surface on an outer circumferential surface thereof.

10. The vehicle operation system according to claim 8, wherein
the virtual input section graphic is a three-dimensional figure which represents a disc, a fan body, an annular body or a part of the annular body, and the virtual input section graphic has the virtual reference operation surface and the virtual three-dimensional operation surface on an outer circumferential surface thereof.

11. The vehicle operation system according to claim 9, wherein
the virtual input section graphic has at least one set of a combination of a simulated reference operation surface that simulates the virtual reference operation surface and a simulated three-dimensional operation surface that simulates the virtual three-dimensional operation surface on the outer circumferential surface, and
the combination of the simulated reference operation surface and the simulated three-dimensional operation surface is disposed to be connected to the combination of the virtual reference operation surface and the virtual three-dimensional operation surface, in the direction in which the virtual reference operation surface and the virtual three-dimensional operation surface are alternately disposed.
